(19) United States
(12) Patent Application Publication
(10) Pub. No.: US 2002/0141499 A1
(43) Pub. Date: Oct. 3, 2002

(54) Scalable programmable motion image system

(76) Inventor: Kenbe D. Goertzen, Topeka, KS (US)

Correspondence Address: John J. Stickevers, Bromberg & Sunstein LLP, 125 Summer Street, Boston, MA, 02110-1618, US

(21) Appl. No.: 10/076,215

(22) Filed: Feb. 13, 2002

Related U.S. Application Data
(63) Continuation-in-part of application No. 09/498,323, filed on Feb. 4, 2000.
(60) Provisional application No. 60/118,556, filed on Feb. 4, 1999.
(60) Provisional application No. 60/268,390, filed on Feb. 13, 2001.
(60) Provisional application No. 60/282,127, filed on Apr. 6, 2001.
(60) Provisional application No. 60/351,463, filed on Jan. 25, 2002.

(51) Int. Cl. H04N 7/12

(52) U.S. Cl. 375/240.12; 375/240.19

(57) ABSTRACT

A scalable motion image compression system for a digital motion image signal having an associated transmission rate. The scalable motion image compression system includes a decomposition module for receiving the digital motion image signal, decomposing the digital motion image signal into component parts and sending the components. The decomposition module may further perform color rotation, spatial decomposition and temporal decomposition. The system further includes a compression module for receiving each of the component parts from the decomposition module, compressing the component part, and sending the compressed component part to a memory location. The compression module may perform sub-band wavelet compression and may further include functionality for quantization and entropy encoding.

The present application is a continuation-in-part of U.S. patent application Ser. No. 09/498,323, entitled “Scalable Resolution Motion Image Recording and Storage System” which was filed on Feb. 4, 2000 and which claims priority from U.S. Provisional Patent Application 60/118,556 which was filed on Feb. 4, 1999. The present application further claims priority from U.S. Provisional Patent Application 60/268,390 entitled “CODEC” which was filed on Feb. 13, 2001 having Atty. Docket No. 2418/122, from U.S. Provisional Patent Application 60/282,127 entitled “CODEC” which was filed on Feb. 6, 2001 having Atty. Docket No. 2418/124 and also from U.S. Provisional Patent Application 60/351,463 entitled “Digital Mastering Codec ASIC” which was filed on Jan. 25, 2002 having Atty. Docket No. 2418/130 all of which are incorporated by reference herein in their entirety.

### TECHNICAL FIELD AND BACKGROUND ART

The present invention relates to digital motion images and more specifically to an architecture for scaling a digital motion image system to various digital motion image formats.

### BACKGROUND ART

Over the last half century, single format professional and consumer video recording devices have evolved into sophisticated systems having specific functionality which film makers and videographers have come to expect. With the advent of high definition digital imaging, the number of motion image formats has increased dramatically without standardization. As digital imaging has developed, techniques for compressing the digital data have been devised in order to allow for higher resolution images and thus, more information to be stored in the same memory space as an uncompressed lower resolution image. In order to provide for the storage of higher resolution images, manufacturers of recording and storage devices have added compression technology into their systems. In general, the current compression technology is based upon the spatial encoding of each image in a video sequence using the discrete cosine transform (DCT). Inherent in such processing is the fact that the spatial encoding is block-based. Such block-based systems do not readily allow for scalability due to the fact that as the image resolution increases the compressed data size increases proportionately. A block transform system cannot see correlation on block boundaries or at frequencies lower than the block size. Due to the low frequency bias of the typical power distribution, as the image size grows, more and more of the information will be below the horizon of a block transform. Therefore, a block transform approach to spatial image compression will tend to produce data sizes at a given quality proportional to the image size. Further, as the resolution increases tiling effects due to the block based encoding become more noticeable and thus there is a substantial image loss including artifacts and discontinuities. Because of these limitations, manufactures have designed their compression systems for a limited range of resolutions. For each resolution that is desired by the film industry, these manufacturers have been forced to readdress these shortcomings and develop resolution specific applications to compensate for the spatial encoding issues. As a result, development of image representation systems which are scalable to motion image streams having different throughputs have not developed.

### SUMMARY OF THE INVENTION

A scalable motion image compression system for a digital motion image signal having an associated transmission rate is disclosed. The scalable motion image compression system includes a decomposition module for receiving the digital motion image signal, decomposing the digital motion image signal into component parts and sending the components. The decomposition module may further perform color rotation, spatial decomposition and temporal decomposition. The system further includes a compression module for receiving each of the component parts from the decomposition module, compressing the component part, and sending the compressed component part to a memory location. The compression module may perform sub-band wavelet compression and may further include functionality for quantization and entropy encoding.

Each decomposition module may include one or more decomposition units which may be an ASIC chip. Similarly each compression module may include one or more compression units which may be a CODEC ASIC chip.

The system may compress the input digital motion image stream in real-time at the transmission rate. The system may further include a programmable module for routing the decomposed digital motion image signal between the decomposition module and the compression module. The programmable module may be a field programmable gate array which acts like a router. In such an embodiment the decomposition module has one or more decomposition units and the compression module has one or more compression units.

In another embodiment the field gate programmable array is reprogrammable. In yet another embodiment the decomposition units are arranged in parallel and each unit receives a part of the input digital motion image signal stream such that the throughput of the decomposition units in total is greater than the transmission rate of the digital motion image stream. The decomposition modules in certain embodiments are configured to decompose the digital motion image stream by color, frame or field. The decomposition module may further perform color decorrelation. Both the decomposition module and the compression module are reprogrammable and have memory for receiving coefficient values which are used for encoding and filtering. It should be understood by one of ordinary skill in the art that the system may equally be used for decompression a compressed digital motion image stream. Each module can receive a new set of coefficients and thus the inverse filters may be implemented.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing an exemplary embodiment of the invention for a scalable video system;

FIG. 2 is a block diagram showing multiple digital motion image system chips coupled together to produce a scalable digital motion image system;

FIG. 2A is a flow chart which shows the flow of a digital motion image stream through the digital motion image system;

FIG. 2B shows one grouping of modules;

FIG. 3 is a block diagram showing various modules which may be found on the digital motion image chip;

FIG. 4 is a block diagram showing the synchronous communication schema between DMRs and CODECs;

FIG. 5 shows a block diagram of the global control module which provides sync signal to each DMR and CODEC within a single chip and when connected in an array may provide a sync signal to all chips in the array via a bus interface module (not shown);

FIG. 6 is a block diagram showing one example of a digital motion image system chip prior to configuration;

FIGS. 7A and 7B are block diagrams showing the functioning components of the digital motion image system chip of FIG. 6 after configuration;

FIG. 8 is a block diagram showing the elements and buses found within a CODEC;

FIG. 9 is a block diagram showing a spatial polyphase processing example; and

FIG. 10 is a block diagram showing a spatial sub-band split example using DMRs and CODECs.

### DETAILED DESCRIPTION OF SPECIFIC EMBODIMENTS

Definitions. As used in this description and the accompanying claims, the following terms shall have the meanings indicated, unless the context otherwise requires:

A pixel is an image element and is normally the smallest controllable color element on a display device. Pixels are associated with color information in a particular color space. For example, a digital image may have a pixel resolution of 640×480 in RGB (red,green,blue) color space. Such an image has 640 pixels in 480 rows in which each pixel has an associated red color value, green color value, and blue color value. A motion image stream may be made up of a stream of digital data which may be partitioned into fields or frames representative of moving images wherein a frame is a complete image of digital data which is to be displayed on a display device for one time period. A frame of a motion image may be decomposed into fields. A field typically is designated as odd or even implying that either all of the odd lines or all of the even lines of an image are displayed during a given time period. The displaying of even and odd fields during different time periods is known in the art as interlacing. It should be understood by one of ordinary skill in the art that a frame or a pair of fields represents a complete image. As used herein the term “image” shall refer to both fields and frames. Further, as used herein, the term, “digital signal processing”, shall mean the manipulation of a digital data stream in an organized manner in order to change and/or segment the data stream.

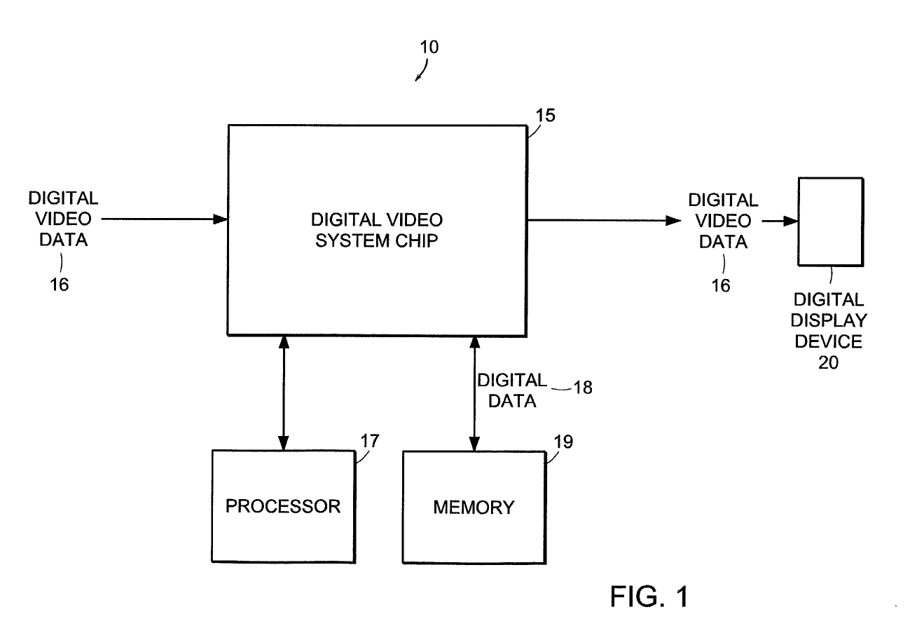

FIG. 1 is a block diagram showing an exemplary embodiment of the invention for a scalable video system 10. The system includes a digital video system chip 15 which receives a digital motion image stream into an input 16. The digital motion image system chip 15 preferably is embodied as an application specific integrated circuit (ASIC). A processor 17 controlling the digital motion image system chip provides instructions to the digital motion image system chip which may include various instructions, such as routing, compression level settings, encoding, including spatial and temporal encoding, color decorrelation, color space transformation, interlacing, and encryption. The digital motion image system chip 15 compresses the digital motion image stream 16 creating a digital data stream 18 in approximately real-time and sends that information to memory for later retrieval. A request may be made by the processor to the digital motion image system chip which will retrieve the digital data stream and reverse the process such that a digital motion image stream is output 16. From the output, the digital motion image stream is passed to a digital display device 20.

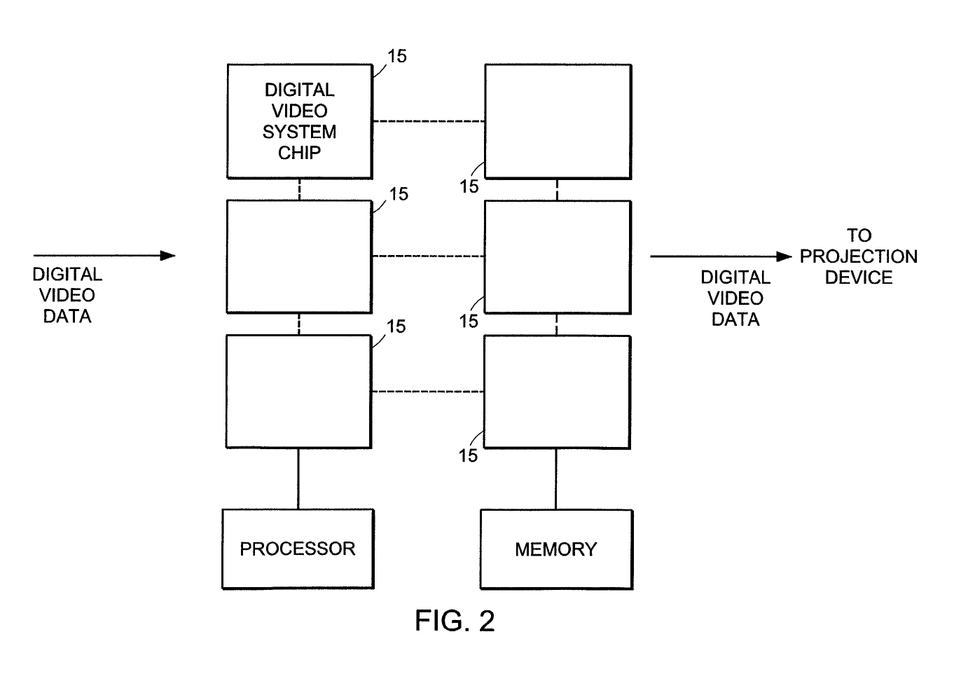

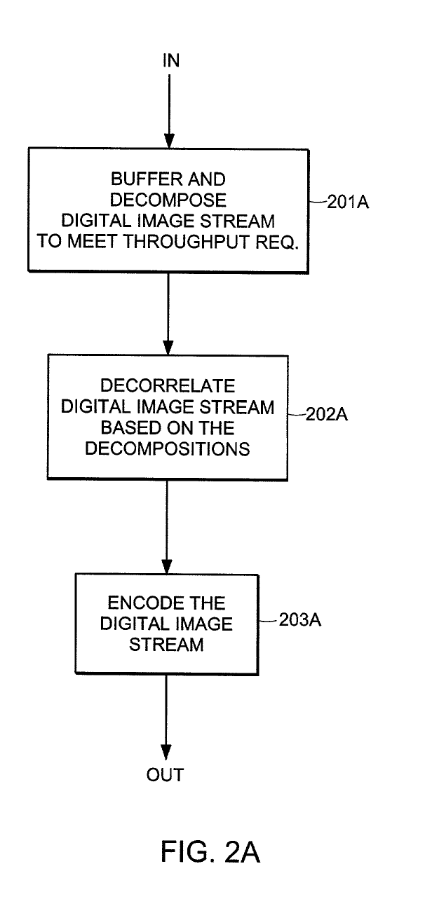

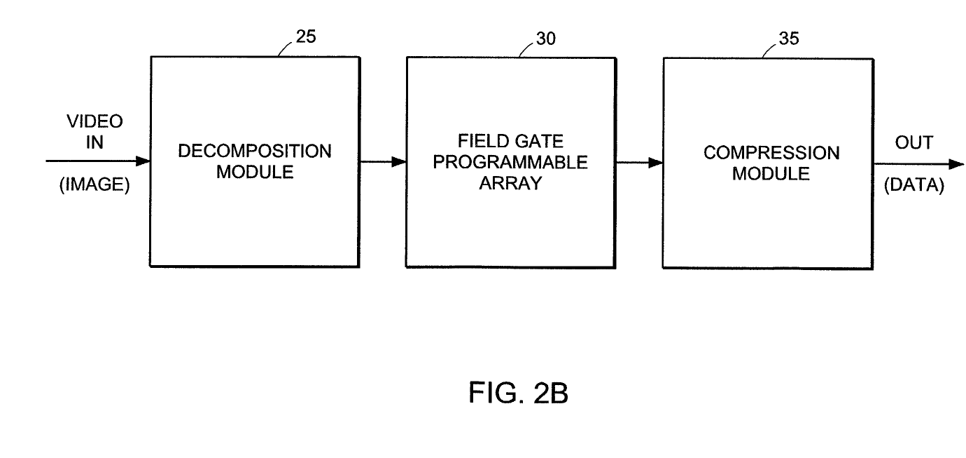

FIG. 2 is a block diagram showing multiple digital motion image system chips 15 coupled together to produce a scalable digital motion image system which can accommodate a variety of digital motion image streams each having an associated resolution and associated throughput. For example, a digital motion image stream may have a resolution of 1600×1200 pixels per motion image with each pixel being represented by 24 bits of information (8 bits red, 8 bits green, 8 bits blue) and may have a rate of 30 frames per second. Such a motion image stream would need a device capable of a throughput of 1.38 Gbits/sec peak rate. The system can accommodate a variety of resolutions including 640×480, 1280×768 and 4080×2040 for example through various configurations.

The method for performing this is shown in FIG. 2A. First the digital motion image stream is received into the system. Depending on the throughput, the stream is separated at definable points such as frame, or line points within an image and distributed to one of a plurality of chips so that the chips provide a buffer in order to accommodate the throughput of the digital motion image stream (Step 201A). The chips then each perform a decomposition of the image stream such as by color component, or by field. The chips will then decorrelate the digital image stream based upon the decompositions (Step 202A). For instance the color components may be decorrelated to separate out luminance or the each image (field/frame) in the stream may be transform sub-band coded. The system then performs encoding of the stream through quantization and entropy encoding to further compress the amount of data which is representative of the digital motion images (Step 203A). The steps will be further described below.

If a component on the digital motion image system chip is incapable of providing such a peak throughput individually, the chips may be electrically coupled in parallel and/or in series to provide the necessary throughput by first buffering the digital motion image stream and then decomposing the digital motion image stream into image components and redistributing the components among other motion image system chips. Such decomposition may be accomplished with register input buffers. For example, if the necessary throughput was twice the capacity of the digital motion image chip, two registers having the wordlength of the motion image stream would be provided such that the data would be placed into the register at the appropriate frequency, but would be read from the registers at half the frequency or two wordlengths per cycle. Further, multiple digital motion image system chips could be linked to form such a buffer. Assuming a switch which can operate at the rate of the digital motion image stream, each digital motion image system chip could receive and buffer a portion of the stream. For example assume that the digital motion image stream is composed of a 4000×4000 pixel monochrome images at 30 frames per second. The throughput that is required is 480 million components per second. If a digital motion image system chip only has a maximum throughput of 60 million components per second, the system could be configured such that a switch which operates at 480 million components per second switches between one of eight chips sequentially. The digital video system chips would then each act as a buffer. As a result, the digital motion image stream may then be manipulated in the chips. For example, the frame ordering could be changed, or the system could add or remove a pixel, field or frame of data.

After buffering the digital motion image stream is decomposed. For example, the digital motion image system chip may provide color decomposition such that each motion image is separated into its respective color components, such as RGB or YUV color components. During the decomposition, the signal may also be decorrelated. The colors can be decorrelated by means of a coordinate rotation in order to isolate the luminance information from the color information. Other color decompositions and decorrelations are also possible. For example, a 36 component Earth Resources representation may be decorrelated and decomposed wherein each component represents a frequency band and thus both spatial and color information are correlated. Typically, the components share both common luminance information and also have significant correlation to proximate color components. In such a case, a wavelet transform can be used to decorrelate the components.

In many digital image stream formats, color information is mixed with spatial and frequency information, such as, color masked imagers in which only one color component is sampled at each pixel location. Color decorrelation requires both spatial and frequency decorrelation in such situation. For example assume a 4000×2000 pixel camera uses a 3 color mask (blue, green, green, red in a 2×2 repeated grid) and operates at a frame rate of up to 72 Hz. This camera would then provide up to 576 million single component pixels per second. Assuming that the system chip can input 600 million components and process 300 million components per second, two system chips can be used as a polyphase frame buffer and a four phase convolver may be passed over the data at 300 mega-components per second. Each phase of the convolver corresponds to one of the phases in the color mask, and produces as an output four independent components. A two dimensional half band low frequency luminance component, a two dimensional half band high frequency diagonal luminance component, a two dimensional half band Cb color difference component and a two dimensional half band Cr color difference component. The information bandwidth of the process is preserved wherein four independent equal bandwidth components are produced and the colorspace is decorrelated. The two dimensional convolver just described incorporates interpolation, color space decorrolation, bandlimiting, and subband decorrolation into a single multiphase convolution. It should be understood by those of ordinary skill in the art that further decompositions are possible. These various types of decorrelations and decompositions are possible because of the modularity of the digital motion image system. As explained further below, each element of the chip is externally controlled and configurable. For instance, separate elements exist within chip for performing color decomposition, spatial encoding and temporal encoding in which each transformation is designed to be a multi-tap filter which is defined by its coefficient values. The external processor may input different coefficient values for a particular element depending on the application. Further, the external processor can select the relevant elements to be used for processing. For instance, a digital motion image system chip may be used solely for buffering and color decomposition, used for only spatial encoding, or used for spatial and temporal encoding. This modularity within the chip is provided in part by a bus to which each element is coupled.

A motion image may further be decomposed by separating the frame into fields. The frame or field may be further decomposed based upon the frequency makeup of the image, for example, such that low, medium, and high frequency components of the image are grouped together. It should be understood by those skilled in the art that other frequency segmentations are also possible. It should also be noted that the referenced decompositions are non-spatial thereby eliminating discontinuities in the reconstructed digital motion image stream upon decompression which are prevalent in block based compression techniques. As described, the overall throughput may be increased by a factor N due to parallel processing as a result of decorrelation of the digital motion image stream. For example, N would be 27:1 in the following example where the image is divided into fields (2:1 gain) and then divided into color components (3:1) gain and then divided into frequency components (3:1) gain. Therefore, the overall increase in throughput is 27:1 such that the final processing in which the actual compression and encoding occurs may be accomplished at a rate which is 1/27^{th} the rate of the input motion image stream. Thus, throughout which is tied to the resolution of the image may be scaled. In the example, since a motion image chip has the I/O capacity for a 1.3 Gcomponents/s for a simple interlace decomposition, a pair of motion image chips may be connected at output ports of the first motion image chip, then color component decomposition may be performed in the second pair of motion image chips where the color decomposition does not exceed 650 Mbits/sec and therefore the overall throughput is maintained. Further decompositions may be accomplished on a frame by frame basis which is generally referred to in the art as poly-phasing.

The digital motion image stream itself may come in over multiple channels into a motion image chip. For example, a Quad-HD signal might be segmented over 8 channels. In this configuration eight separate digital motion image chips could be employed for compressing the digital motion image stream, one for each channel.

Each motion image has an input/output (I/O) port or pin for providing data between the chips and a data communications port for providing messaging between the chips. It should be understood that a processor controls the array of chips providing instructions regarding the digital signal processing tasks to be performed on the digital motion image data for each of the chips in the array of chips. Further, it should be understood that a memory input/output port is provided on each chip for communicating with a memory arbiter and the memory locations.

In one embodiment, each digital motion image system chip contains an input/output port along with multiple modules including decomposition modules 25, field gate programmable arrays (FPGA) 30 and compression modules 35. FIG. 2B shows one grouping of modules. In an actual embodiment, several such groupings would be contained on a single chip. As such the FPGAs allow the chip to be programmed so as to configure the couplings between the decomposition modules and the compression modules.

For example, the input motion image data stream may be decomposed in the decomposition module by splitting each frame of motion image stream into its respective color components. The FPGA which may be dynamically reprogrammable FPGAs would be programmed as a multiplexor/router receiving the three streams of motion image information (One for red, one for green and one for blue in this example) and pass that information to the compression module. Although field gate programmable arrays are described other signal/data distributors may be used.. A distributor may distribute the signal on a peer to peer basis using token passing or the distributor may be centrally controlled and distribute signals separately or the distributor may provide the entire motion image input signal to each module masking the portion which the module is not supposed to process. The compression module which is made up of multiple compression units each of which is capable of compressing the incoming stream would then compress the stream and output the compressed data preferably to memory. The compression module of the preferred embodiment employs wavelet compression using sub-band coding on the stream in both space and time. The compression module is further equipped to provide a varying degree of compression with a guaranteed level of signal quality based upon a control signal sent to the compression module from the processor. As such, the compression module produces a compressed signal which upon decompression maintains a set resolution over all frequencies for the sequence of images in the digital motion image stream.

If the component processing rate of the system chip m is less than n where n is the independent component rate, then Roof[m/n] system chips are used. Each system chip receives either every Roof[n/m] pixel or Roof[n/m] frame. The choice is normally determined by the ease of I/O buffering. In the case of pixel polyphase where Roof[n/m] is not a multiple of the line length of the video image that is being processed, line padding is used to maintain vertical correlation. In the case of polyphase by component multiplexing, vertical correlation is preserved and a subband transform can be independently applied to the columns of the image in each part to yield two or more orthogonal subdivision of the vertical component. In the case of polyphase by frame multiplexing, both vertical and horizontal correlation have been maintained, so a two dimensional subband transform can be applied to the frames to produce two or more orthogonal subdivisions of the two dimensional information. The system chip is designed such that the same peak rates at the input and at the output ports are supported. The Roof[n/m] processes output in transposed polyphase fashion, a nonpolyphase, subband representation of the input signal, where there are now more components, and each independent component is at a reduced rate.

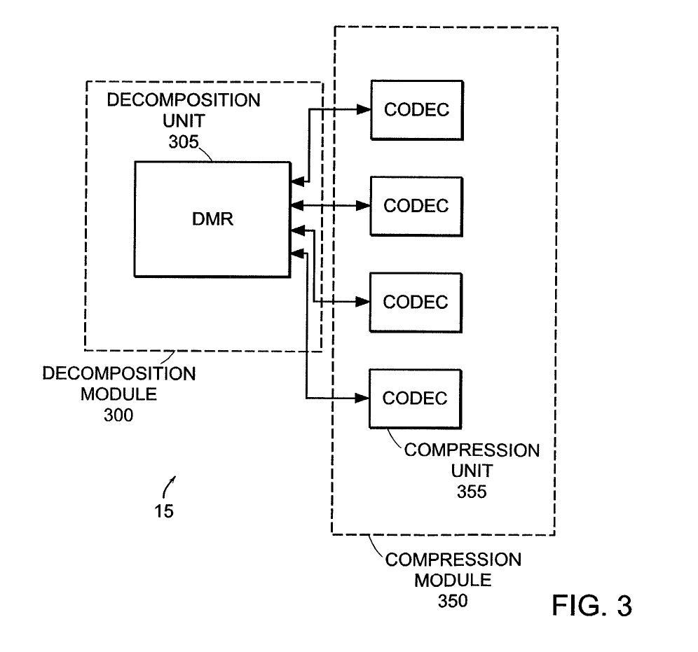

FIG. 3 shows various modules which may be found on the digital motion image chip 15 including a decomposition module 300 which may include one or more decomposition units 305. Such units allow for color compensation, color space rotation, color decomposition, spatial and temporal transformations, format conversion, and other motion image digital signal processing functions. Further such a decomposition unit 305 may be referred to as a digital mastering reformatter (“DMR”). A DMR 305 is also provided with “smart” I/O ports which provide for simplified spatial, temporal and color decorrelations generally with one tap or two tap filters, color rotations, bit scaling through interpolation and decimation, 3:2 pulldown, and line doubling. The smart I/O ports are preferably bi-directional and are provided with a special purpose processor which receives sequences of instructions. Both the input port and the output port are configured to operate independent of each other such that, for example, the input port may perform a temporal decorrelation of color components while the output port may perform an interlaced shuffling of the lines of each image. The instructions for the I/O ports may be passed as META data in the digital motion image stream or may be sent to the I/O port processor via the system processor wherein the system processor is a processor which is not part of the digital motion image chip and provides instructions to the chip controlling the chips functionality. The I/O ports may also act as standard I/O ports and pass the digital data to internal application specific digital signal processors which perform higher-order filtering. The I/O processor is synched to the system clock such that upon the completion of a specified sync time interval the I/O ports will under normal circumstances transfer the processed data preferably of a complete frame to the next module and receive in data representative of another frame. If a sync time interval is completed, and the data within the module is not completely processed, the output port will still clear the semi-processed data and the input port will receive in the next set of data. For example, the DMR 305 would be used in parallel and employed as a buffer if the throughput of the digital motion image stream exceeded the throughput of a single DMR 305 or compression module. In such a configuration, as a switch/signal partitioner inputs digital data into each of the DMRs, the DMRs may perform further decompositions and/or decorrelations.

A compression module 350 contains one or more compression/decompression units (“CODECs”) 355. The CODECs 355 provide encoding and decoding functionality (wavelet transformation, quantization/dequantization and entropy encoder/decoder) and can perform a spatial wavelet transformation of a signal (spatial/frequency domain) as well as a temporal transformation (temporal/frequency) of a signal.

In certain embodiments a CODEC includes the ability to perform interlace processing and encryption. The CODEC also has “smart” I/O ports which are capable of simplified decorellations using simple filters such as one-tap and two-tap filters and operate in the same way as the smart I/O ports described above for the DMR. Both the DMR and the CODEC are provided with input and output buffers which provide a storage location for receiving the digital motion image stream or data from another DMR or CODEC and a location for storing data after processing has occurred, but prior to transmission to a DMR or CODEC. In the preferred embodiment the input and output ports have the same bandwidth for both the DMR and the CODEC, but not necessarily the same bandwidth in order to support the modularity scheme. For example, it is preferable that the DMR have a higher I/O rate than that of the CODEC to support polyphase buffering. Since each CODEC has the same bandwidth at both the input and output ports the CODECs may readily be connected via common bus pins and controlled with a common clock.

Further, the CODEC may be configured to operate in a quality priority mode as explained in U.S. patent application Ser. No. 09/498,924 which is incorporated by reference herein in its entirety. In quality priority, each frequency band of a frame of video which has been decorrelated using a sub-band wavelet transform may have a quantization level that maps to a sampling theory curve in the information plane. Such a curve has axes of resolution and frequency and for each octave down from the Nyquist frequency an additional 1.0 bit is needed to represent a two dimensional image. The resolution for the video stream as expressed at the Nyquist frequency is therefore preserved over all frequencies. Based upon sampling theory, for each octave down an additional ½ bit of resolution per dimension is necessary. Therefore, more bits of information are required at lower frequencies to represent the same resolution as that at Nyquist. As such, the peak rate upon quantization can approach the data rate in the sample domain and as such the input and output ports of the CODEC should have approximately the same throughput.

Because high resolution images can be decomposed into smaller units that are compatible with the throughput of the CODEC and do not effect the quality of the image, additional digital signal processing may be done on the image, such as homomorphic filtering, and grain reduction. Quantization may be altered based upon human perception, sensor resolution, and device characteristics, for example.

Thus, the system can be configured in a multiplexed form employing modules which have a fixed throughput to accommodate varying image sizes. The system accomplishes this without the loss due to the horizon effect and block artifacts since the compression is based upon full image transforms of local support. The system can also perform pyramid transforms such that lower and lower frequency components are further subband encoded It should be understood by one of ordinary skill in the art that various configurations of CODECs and DMRs may be placed on a single motion image chip. For example a chip may be made up exclusively of multiplexed CODECs, multiplexed DMRs or combinations of DMRs and CODECs. Further, a digital motion image chip may be a single CODEC or a single DMR. The processor which controls the digital motion image system chip can provide control instructions such that the chip performs N component color encoding using multiple CODECs, variable frame rate encoding (for example 30 frames per second or 70 frames per second), and high resolution encoding.

FIG. 3 further shows the coupling between a DMR 305 and a compression module 350 such that the DMR may send decomposed information to each of a plurality of CODECs 355 for parallel processing. It should be understood that the FPGAs/signal distributors are not shown in this figure. Once the FPGAs are programmed, the FPGAs provide a signal path between the appropriate decomposition module and compression module and thus act as a signal distributor.

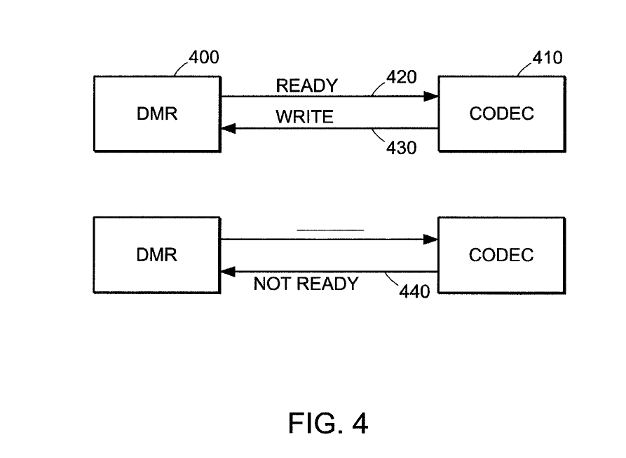

FIG. 4 is a block diagram showing the synchronous communication schema between DMRs 400 and CODECs 410. Messaging between the two units is provided by a signaling channel. The DMR 400 signals to the CODEC 410 that it is ready to write information to the CODEC with a READY command 420. The DMR then waits for the CODEC to reply with a WRITE command 430. When the WRITE command 430 is received the DMR passes the next data unit to the CODEC from the DMRs output buffer into the CODECs input buffer. The CODEC may also reply that it is NOT READY 440 and the DMR will then wait for the CODEC to reply with a READY signal 420, holding the data in the DMR's output buffer. In the preferred embodiment, when the input buffer of the CODEC is within 32 words of being full, the CODEC will issue a NOT READY reply 440. When a NOT READY 440 is received by the DMR, the DMR stops processing the current data unit. This handshaking between modules is standardized such that each decomposition module and each compression module is capable of understanding the signals.

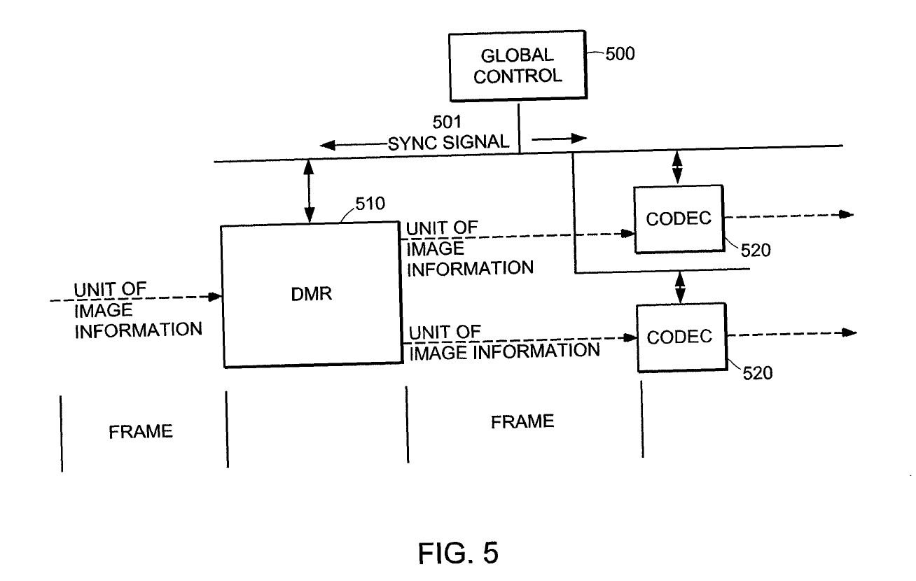

FIG. 5 shows a block diagram of the global control module 500 which provides sync signal 501 to each DMR 510 and CODEC 520 within a single chip and when connected in an array may provide a sync signal to all chips in the array via a bus interface module (not shown). The sync signal occurs at the rate of one frame of a motion image in the preferred embodiment, however the sync signal may occur at the rate of a unit of image information. For example, if the input digital motion image stream is filmed at the rate of 24 frames per second the sync signal will occur every 1/24 of a second. Thus, at each sync signal, information is transferred between modules such that a DMR passes a complete frame of a digital motion image in a decorrelated form to a compression module of CODECs. Similarly a new digital motion image frame is passed into the DMR. The global sync signal overrides all other signals including the READ and WRITE commands which pass between the DMRs and CODECs. The READ and WRITE commands are therefore relegated to interframe periods. The sync signal forces the transfer of a unit of image information (frame in the preferred embodiment) so that frames are kept in sync. If a CODEC takes longer than the period between sync signals to process a unit of image information, that unit is discarded and the DMR or CODEC is cleared of all partially processed data. The global sync signal is passed along a global control bus which is commonly shared by all DMRs and CODECs on a chip or configured in an array. The global control further includes a global direction signal. The global direction signal indicates to the I/O ports of the DMRs and CODECs whether the port should be sending or receiving data. By providing the sync signal timing scheme, throughput of the system is maintained, therefore, the scalable system behaves coherently and can thus recover from soft errors such as transient noise internal to any one component or an outside error such as faulty data.

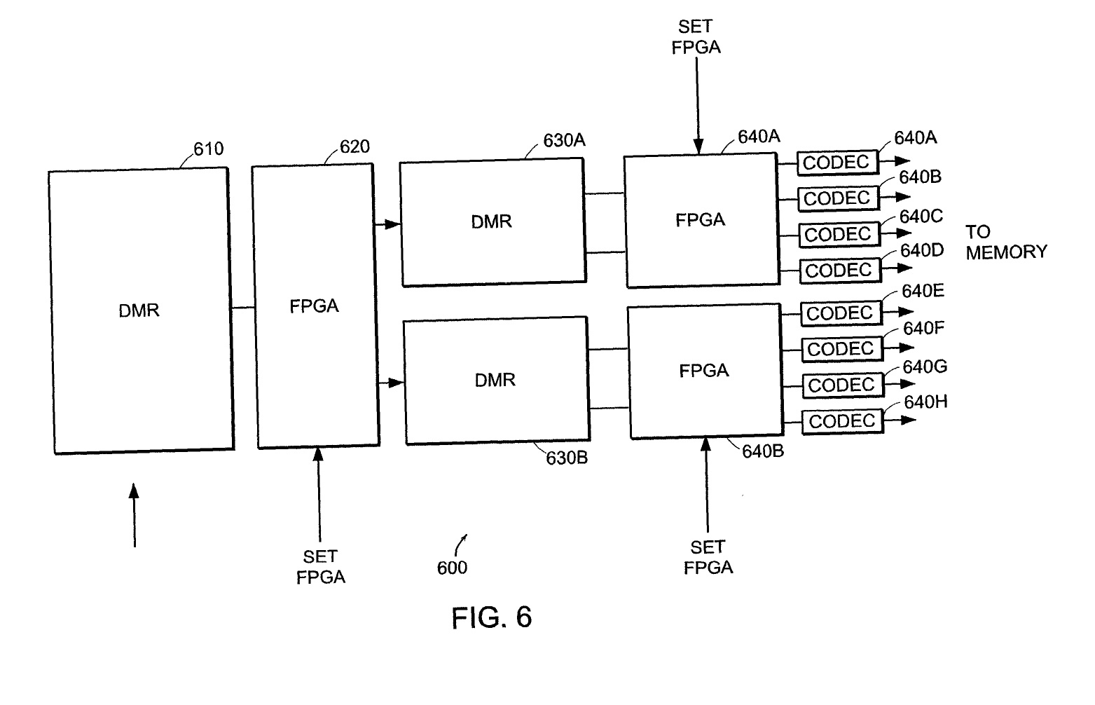

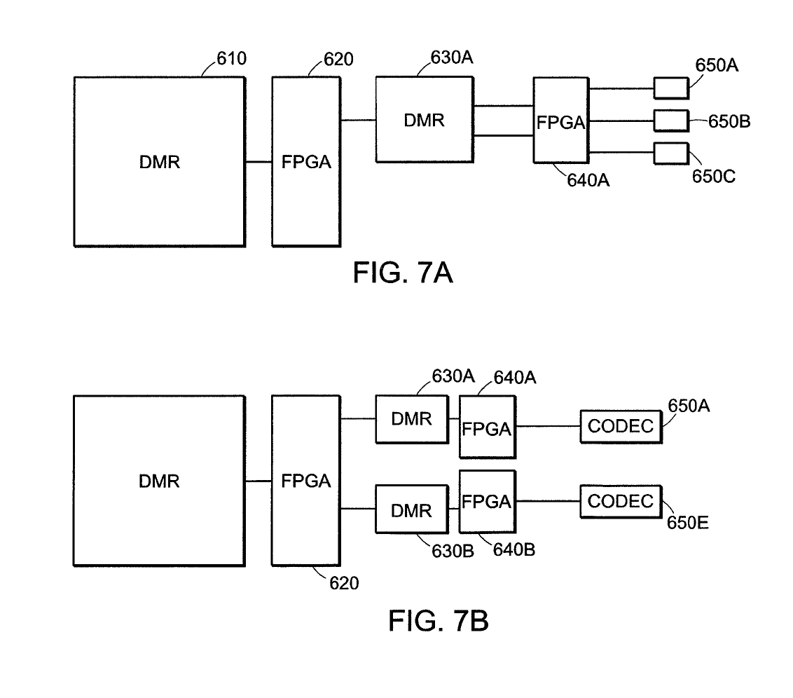

FIG. 6 is a block diagram showing one example of a digital motion image system chip 600. The chip is provided with a first DMR 610 followed by an FPGA 620, followed by a pair of DMRs 630A-B which are each coupled to a second FPGA 640A-B. The FPGAs are in turn coupled to each of four CODECs 650A-H. As was previously stated the FPGAs may be programmed depending upon the desired throughput. For example in FIG. 7A the first FPGA 620 has been set so that it is coupled between the first DMR 610 and the second DMR 630A. The second DMR 630A is coupled to an FPGA 640A which is coupled to three CODECs 650A, 650B, 650C. Such a configuration may be used to divide the incoming digital image stream into frames in the first DMR and then decorrelate the color components for each frame in the second DMR. The CODECs in this embodiment compresses the data for one color component for each motion image frame. FIG. 7B is an alternative configuration for the digital motion image system chip of FIG. 6. In the configuration of FIG. 7B the first FPGA 620 is set so that it is coupled to each of two DMRs 630A, 630B at its output. Each DMR 630A,B then sends data to a single CODEC 650A, E. This configuration may be used first to interlace the motion image frames such that the second DMRs receive either an odd or even field. The second DMRs may then perform color correction or a color space transformation on the interlaced digital motion image frame and then this data is passed to a single CODEC which compresses and encodes the color corrected interlaced digital motion image.

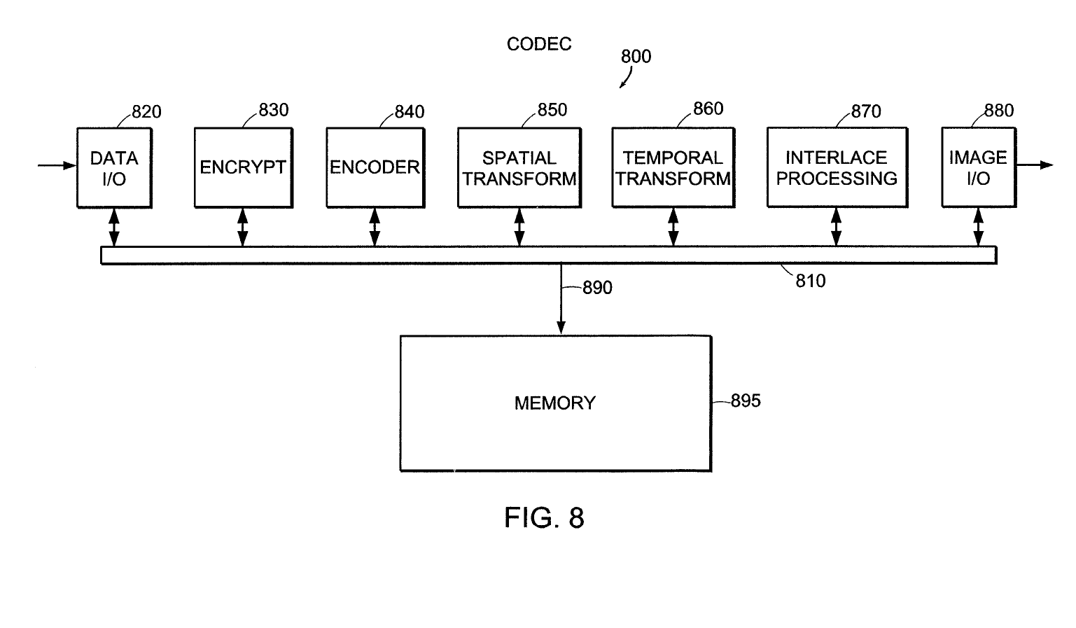

FIG. 8 is a block diagram showing the elements and buses found within a CODEC 800. The elements of the DMR may be identical to that of the CODEC. The DMR preferably has more data rate throughput for receiving higher component/second digital motion image streams and additionally has more memory for buffering received data of the digital motion image stream. The DMR may be configured to simply perform color space and spatial decompositions such that the DMR has a data I/O port and an image I/O port and is coupled to memory wherein the I/O ports contain programmable filters for the decompositions.

The CODEC 800 is coupled to a global control bus 810 which is in control communication with each of the elements. The elements include a data I/O port 820, an encryption element 830, an encoder 840, a spatial transform element 850, a temporal transform element 860, an interlace processing element 870 and an image I/O port 880. All of the elements are coupled via a common multiplexor (mux) 890 which is coupled to memory 895. In the preferred embodiment, the memory is double data rate (DDR) memory. Each element may operate independent of all of the other elements. The global control module issues command signals to the elements which will perform digital signal processing upon the data stream. For example, the global control module may communicate solely with the spatial transform element such that only a spatial transformation is performed upon the digital data stream. All other elements would be bypassed in such a configuration. When more than one element is implemented, the system operates in the following manner. The data stream enters the CODEC through either the data I/O port or the image I/O port. The data stream is then passed to a buffer and then sent to the mux. From the mux the data is sent to an assigned memory location or segment of locations. The next element, for example the encryption element requests the data stored in the memory location which is passed through the multiplexer and into the encryption element. The encryption element may then perform any of a number of encryption techniques. Once the data is processed, it is passed to a buffer and then through the multiplexor back to the memory and to a specific memory location/segment. This process continues for all elements which have received control instructions to operate upon the digital data stream. It should be noted that each element is provided with the address space of the memory to retrieve based upon the initial instructions that are sent from the system processor to the global control processor and then to the modulation in the motion image chip. Finally the digital data stream is retrieved from memory and passed through the image I/O port or the data port. Sending of the data from the port occurs upon the receipt by the CODEC of a sync signal or with a write command.

The elements within the CODEC will be described below in further detail. The image I/O port is a bi-directional sample port. The port receives and transmits data synchronous to a sync signal. The interlace process element provides multiple methods known to those of ordinary skill in the art for preprocessing the frames of a digital motion image stream. The preprocessing helps to correlate spatial vertical redundancies along with temporal field-to-field redundancies. The temporal transform element provides a 9-tap filter that provides for a wavelet transform across temporal frames. The filter may be configured to perform a convolution in which a temporal filter window is slid across multiple frames. The temporal transform may include recursive operations that allow for multi-band temporal wavelet transforms, spatial and temporal combinations, and noise reduction filters. Although the temporal transform element may be embodied in a hardware format as a digital signal processing integrated circuit the element may be configured so as to receive and store coefficient values for the filter from either Meta-data in the digital motion image stream or by the system processor. The spatial transform element like the temporal transform element is embodied as a digital signal processor which has associated memory locations for downloadable coefficient values. The spatial transform in the preferred embodiment is a symmetrical two dimensional convolver. The convolver has an N-number of tap locations wherein each tap has L-coefficients that are cycled through on a sample/word basis (wherein a sample or word may be defined as a grouping of bits). The spatial transform may be executed recursively on the input image data to perform a multi-band spatial wavelet transform or utilized for spatial filtering such as band-pass or noise reduction. The entropy encoder/decoder element performs encoding across an entire image or temporally across multiple correlated temporal blocks. The entropy encoder utilizes an adaptive encoder that represents frequently occurring data values as minimum bit-length symbols and less frequent values as longer bit-length symbols. Long run lengths of zeroes are expressed as single bit symbols representing multiple zero values in a few bytes of information. For more information regarding the entropy encoder see U.S. Pat. No. 6,298,160 which is assigned to the same assignee as the present invention and which is incorporated herein by reference in its entirety. The CODEC also includes an encrypter element which performs both encryption of the stream and decryption of the stream. The CODEC can be implemented with the advanced encryption standard (AES) or other encryption techniques.

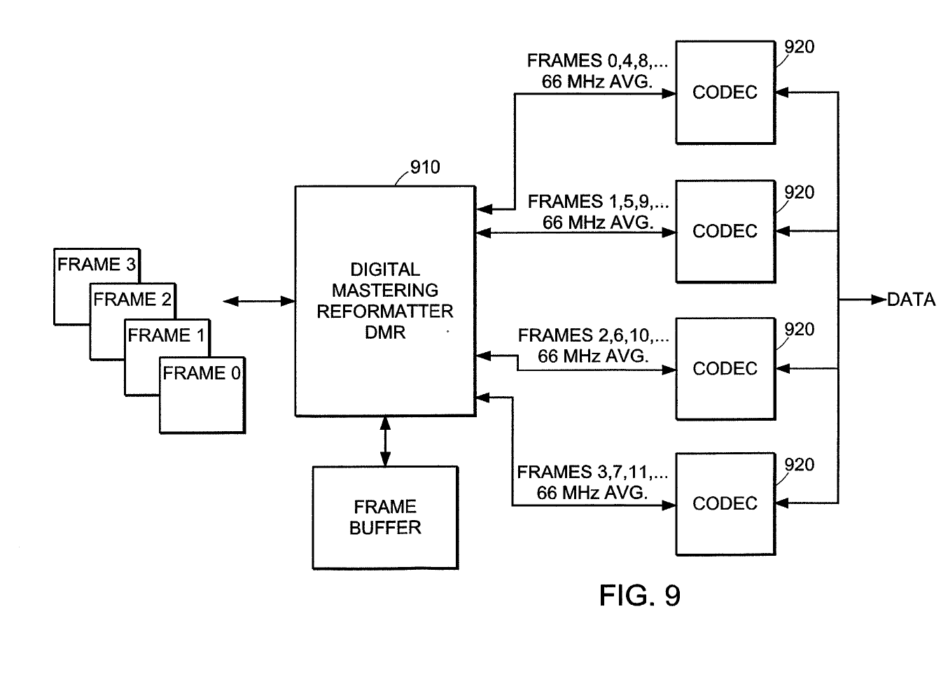

In FIG. 9 is provided a block diagram showing a spatial polyphase processing example. In this example the average data rate of the digital motion image stream is 266 MHz (4.23 Giga-components/second). Each CODEC 920 is capable of processing at 66 MHz, therefore since the needed throughput is greater than that of the CODEC the motion image stream is polyphased. The digital motion image stream is passed into the DMR 910 which identifies each frame thereby dividing the stream up into spatial segments. This process is done through the smart I/O port without using digital signal processing elements internal to the DMR in order to accommodate the 266 MHz bandwidth of the image stream. The smart I/O port of the exemplary DMR is capable of frequency rates of 533 MHz while the digital signal processing elements operates at a maximum rate of 133 MHz. The smart I/O port of the s DMR passes the spatially segmented image data stream into a frame buffer as each frame is segmented. The CODEC signals the DMR that it is ready to receive data as described above with respect to FIG. 4. The DMR retrieves a frame of image data and passes it through a smart I/O port to the first CODEC. The process continues for each of the four CODEC such that the second CODEC receives the second frame, the third CODEC receives the third frame and the fourth CODEC receives the fourth frame. The process cycles through back to the first CODEC until the entire stream is processed and passed from the CODECs to a memory location. In such an example, the CODECs may perform wavelet encoding and compression of the frame and other motion image signal processing techniques. (Define motion image signal proceedings).

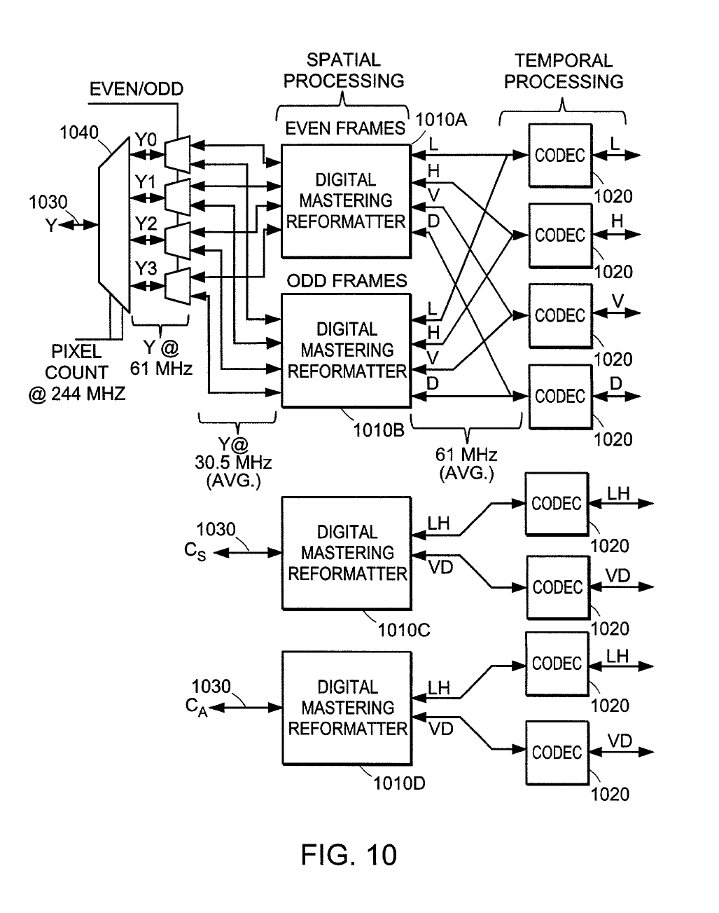

FIG. 10 is a block diagram showing a spatial sub-band split example using DMRs 1010 and CODECs 1020. In this example a Quad HD image stream (3840×2160×30 frames/sec or 248 MHz) is processed. The input motion image stream is segmented into color components by frames upon entering the configuration shown. The color components for a frame are in Y,Cb,Cr format 1030. The DMR 1110 performs spatial processing on the frames of the image stream and pass each frequency band to the appropriate CODEC for temporal processing. Since the chrominance components are only half-band (Cb, Cr) each component is processed using only a single DMR and two CODECs. The luminance component (Y) is first time-multiplexed 1040 through a high speed multiplexor operating at 248 MHz wherein even components are passed to a first DMR 1110A and odd components are passed to a second DMR 1110B. The DMR then uses a two dimensional convolver outputting four frequency components L,H,V,D (Low, High, Vertical, Diagonal). The DMR performs this task at the rate of 64 MHz for an average frame. The DMRs 1010C,D that process the Cb and Cr components also use a two dimensional convolver (having different filter coefficients than that of the two dimensional convolver for the Y component) to obtain a frequency split of LH (Low High) and VD (Vertical Diagonal) for each component. The CODEC 1020 then process a component of the spatially divided frame. In the present example, the CODEC performs a temporal conversion over multiple frames. (Need additional disclosure on the temporal conversion process). It should be understood that the DMRs and the CODECs are fully symmetrical and can be used to encode and decode images.

It should be understood by one of ordinary skill in the art that although the above description has been described with respect to compression that the digital motion image system chip can be used for the decompression process. This functionality is possible because the elements within both the DMR and the CODEC may be altered by receiving different coefficient values and in the case of the decompression process may receive the inverse coefficients.

In an alternative embodiment, the disclosed system and method for a scalable digital motion image compression may be implemented as a computer program product for use with a computer system as described above. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a compute program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A scalable motion image compression system for a digital motion image signal wherein the digital motion image signal has an associated transmission rate, the system comprising:
a decomposition module for receiving the digital motion image signal at the transmission rate, decomposing the digital motion image signal into component parts and sending the components at the transmission rate; and
a compression module for receiving each of the component parts from the decomposition module, compressing the component part, and sending the compressed component part to a memory location.

2. A scalable motion image compression system according to claim 1, wherein the decomposition module includes one or more decomposition units.

3. A scalable motion image compression system according to claim 1, wherein the digital motion image signal is compressed at the transmission rate.

4. A scalable motion image compression system according to claim 1 further comprising a programmable module for routing the decomposed digital motion image signal between the decomposition module and the compression module.

5. A scalable motion image compression system according to claim 4, wherein the programmable module is a field programmable gate array.

6. A scalable motion image compression system according to claim 5, wherein the field programmable gate array is reprogrammable.

7. A scalable motion image compression system according to claim 1, wherein the compression module includes one or more compression units.

8. A scalable motion image compression system according to claim 7, wherein the throughput of a compression unit multiplied by the number of compression units is greater than or equal to the transmission rate of the digital motion image signal.

9. A scalable motion image compression system according to claim 7, wherein each compression unit operates in parallel.

10. A scalable motion image compression system according to claim 1, wherein the decomposition module includes one or more decomposition units.

11. A scalable motion image compression system according to claim 1, wherein each decomposition unit operates in parallel.

12. A scalable motion image compression system according to claim 1, wherein the decomposition module performs color decorrelation.

13. A scalable motion image compression system according to claim 1, wherein the decomposition module performs color rotation.

14. A scalable motion image compression system according to claim 1, wherein the decomposition module performs temporal decomposition.

15. A scalable motion image compression system according to claim 1, wherein the decomposition module performs spatial decomposition.

16. A scalable motion image compression system according to claim 1, wherein the compression module uses subband coding.

17. A scalable motion image compression system according to claim 13, wherein the subband coding uses wavelets.

18. A scalable motion image compression system according to claim 1, wherein the spatial decomposition is spatial polyphase decomposition.

19. A scalable system for performing motion image compression of a digital motion image input signal having an associated transmission rate, the system comprising:
a plurality of compression blocks, each block having a decomposition module and a compression module
a signal distributor coupled to the compression blocks for partitioning the digital motion image input signal into a plurality of segments providing a distinct component of the input signal to each of the compression units;
the decomposition module decomposing a segment into component parts and sending the components; and
a compression module for receiving a component from a corresponding decomposition module, compressing the component, and sending the compressed component part to a memory location.
